(19) United States
(12) Patent Application Publication
(10) Pub. No.: US 2005/0173381 A1
(43) Pub. Date: Aug. 11, 2005

(54) Plasma cutting process and unit with current slaved to the plasma gas

(75) Inventor: Michel Delzenne, Franconville (FR)

Correspondence Address: Linda K. Russell, Suite 1800, 2700 Post Oak Blvd, Houston, TX, 77056, US

(73) Assignees: L'Air Liquide, Societe Anonyme a Directoire et Conseil de Surveillance pour I'Etude et I'Exploita; La Soudure Autogene Francaise

(21) Appl. No.: 11/044,785

(22) Filed: Jan. 27, 2005

(30) Foreign Application Priority Data
Jan. 27, 2004 (FR) 0450136

(51) Int. Cl. B23K 9/00

(52) U.S. Cl. 219/121.39; 219/121.41

(57) ABSTRACT

A plasma cutting process for cutting a metal workpiece using a plasma cutting torch supplied with electrical current and with at least plasma gas. At least one portion of the current ramp-up used at the start of cutting and/or of the current ramp-down used at the end of cutting, respectively, is slaved to the ramp-up in pressure and/or in flow rate of the gas used, at the start of cutting, and/or the ramp-down in pressure and/or in flow rate of the gas used, at the end of cutting.

The invention relates to a plasma cutting process and a plasma cutting unit with current slaved to the plasma gas.

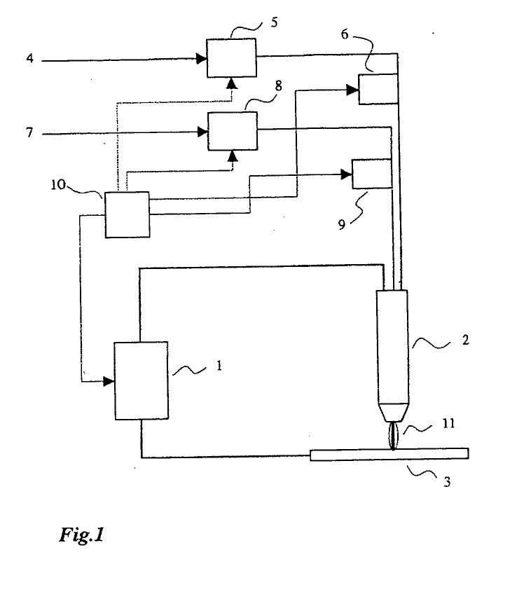

As shown in FIG. 1, a plasma cutting unit generally comprises at least one electrical current source 1 connected via is poles, on one side, to the electrode of a torch 2 and, on the other side, to the workpiece 3 to be cut, which forms the other electrode; a source 4 of ignition gas, also called pilot gas, supplying the torch 2 via a pressure-regulating means 5 for regulating the pilot gas pressure and an isolating valve 6 for opening the pilot gas to the torch 2 or for closing it, depending on the sequencing steps associated with the cutting work; and a source 7 of cutting gas supplying the torch 2 via a pressure-regulating means 8 for regulating the cutting gas pressure and an isolating valve 9 for opening the cutting gas line to the torch 2 or for closing it, depending on the sequencing steps associated with the cutting work; and a control device 10 for controlling the operating sequences of the plasma cutting unit, by opening/closing the isolating valves 6 and 9 and increasing/decreasing the current from the electrical source 1, both for the ignition phases and for the cutting phases.

If the pressure-regulating means 5 and 8 are not manually adjusted members but members that are remotely controllable according to an operating setpoint, the device 10 also controls, before, simultaneously with or after the opening of the isolating valves 6 and 9, the operation of the regulating members 5 and 8.

During a cutting operation, the prior operations, of striking an arc and of transferring it to the workpiece to be cut, having been carried out, the device 10 commands, on the basis of information attesting the transfer of the arc, for example by means of a current sensor (not shown) placed in the electrical circuit connecting the electrical current source 1 to the workpiece 3 to be cut, on the one hand, the replacement of the pilot gas with the cutting gas by causing the pilot gas isolating valve 6 to close and, almost simultaneously, causing the cutting gas isolating valve 9 to open, and, on the other hand, the rise in current from the electrical source 1, as a predefined ramp in order to pass from the “pilot” current value to the “cutting” current value so as to establish a plasma arc 11 suitable for the cutting operation that has to follow.

At the end of the cutting operation, through a predefined programme or upon an order by the operator, a cycle stop control signal is sent to the device 10, which then commands the electrical source 1 to stop the current and, simultaneously with or after a predefined delay, causes the cutting gas isolating valve 9 to close.

When the pressure-regulating member 8 is a member that can be remotely controlled according to an operating setpoint, a predefined ramp for opening the member 8 or for raising the pressure is commanded, before, simultaneously with or after, the command to open the isolating valve 9 and, conversely, a predefined closure or pressure-lowering ramp is commanded by the device 10 before, simultaneously with or after closure of the cutting gas isolating valve 9.

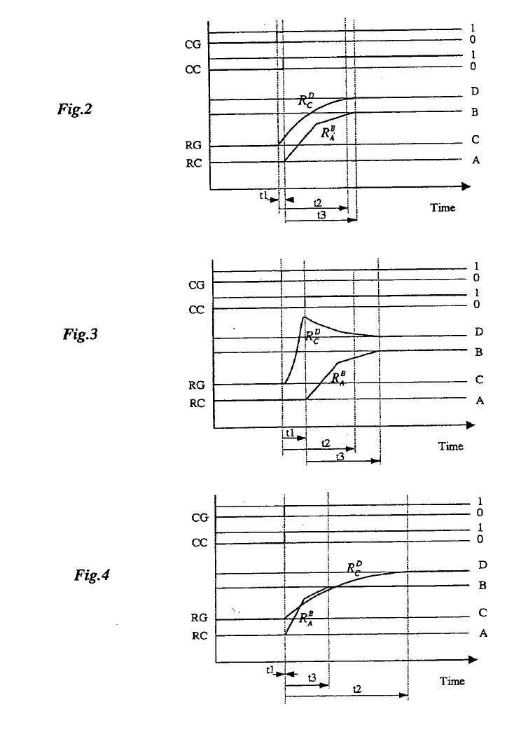

Given that the problems associated with managing the cutting gas ramps and cutting current ramps in the phases prior to the start of cutting and at the end of cutting are similar, only the phase prior to the start of cutting, that is to say the phase commencing after transfer of the pilot arc to the workpiece and finishing when the pressure or the flow rate of cutting gas and the cutting current have reached the nominal values propitious for starting the actual cutting operation, is detailed below with reference to the appended FIGS. 2 to 3.

FIG. 2 shows schematically, in the form of a graph, in its upper part, the commands given, on the one hand, to the actuators for the cutting gas line CG and, on the other hand, to the electrical current source CC. The level 0 corresponds to the initial state of the actuators before the command and the level 1 to the state after the command.

The lower part of FIG. 2 also shows schematically, in the situation in which the pressure regulator 8 is a remotely controlled member with an adjustable pressure rise time, the result obtained by these commands, namely the result in the case of the cutting gas (RG) and that in the case of the cutting current (RC).

In the case of the cutting gas (CG), the commands are:
an initial flow rate state RG of level C for a CG state 0;
from the CG state 1, a flow rate ramp-up R_{C}^{D} from the level C to the level D, resulting from controlling the pressure increase of the regulator 8 over a time t2, set by the initial setting or predefined programme;
at the end of t2, a pressure state according to the setpoint imposed on the controlled regulator 8; and
at the end of the current rise, that is to say at the end of t3, a flow rate state RG of level D corresponding to the nominal level required for the actual cutting operation.

Moreover, in the case of the cutting current (CC), the commands are:
an initial current state RC of level A for a CC state 0;
from the CC state 1, after a time t1, by initial adjustment or predefined programme, with respect to the CG state 1, a current ramp-up R_{A}^{B} from level A to level B in a time t3 set by the initial setting or predefined programme; and
at the end of t3, a current state RC of level B corresponding to the nominal level required for the actual cutting operation.

In fact, FIG. 2 shows an ideal case of good programming of the parameters t1, t2 and t3, for which the gas flow rate ramp R_{C}^{D} and the current ramp R_{A}^{B} are in synchronism, without generating any dysfunction in establishing the cutting arc.

FIG. 3 repeats a sequence similar to FIG. 2, illustrating the consequences of incorrectly choosing the time t1 and possibly the time t3, in this case time values that are too long.

After the command to switch from CG state 0 to state 1, that is to say after the cutting gas valve 9 has been opened (cf. FIG. 1) and over the entire time t1, the cutting gas flow rate RG, starting from the level C with a view to reaching the level D, is not limited by an accompanying synchronous increase in the current RC which, under normal conditions, creates a head loss in the plasma jet ejection nozzle of the torch 2 that is substantially proportional to the value of the current.

In order to maintain a pressure supplied to the torch 2 that is substantially in accordance with the predetermined adjustment setpoint, the cutting gas pressure regulator 8 then delivers cutting gas with a flow rate above the level D until the end of t1, and then, after the command to switch from CC state 0 to state 1, governing the start of the rise in current RC, a reduction in flow rate substantially proportional to the rise in current, from the end of t1 and, in the particular case when the end of t2 occurs before the end of t3, until the end of the cutting current ramp-up R_{A}^{B} that is to say until the end of t3, in order finally to achieve the required level D.

In such circumstances, the excess flow of cutting gas created generally has deleterious consequences, in particular on:
the attachment of the plasma arc cathode root to the electrode of the torch, since the excess flow of cutting gas runs the risk of blowing out the plasma arc at its cathode root and of inadvertently extinguishing it, and consequentially stopping the cutting operation; and
the lifetime of the electrode of the torch. The sudden momentary excess flow of cutting gas destabilizes the portion of the molten metal that forms the emissive region of the electrode, that is to say it breaks the equilibrium of the system of forces that maintains cohesion between the liquid metal and the solid metal and expels the liquid portion that is then entrained by the plasma jet towards the ejection orifice of the nozzle, thus resulting in rapid wear of the electrode.

FIG. 4 repeats a sequence similar to FIGS. 2 and 3, illustrating the consequences of incorrectly choosing the times t1 and t3, in this case time values that are too short, combined with an incorrect choice of the time t2, in this case too long a time value.

Since the offset time t1 between the command to switch from CG state 0 to state 1 at the start of the cutting gas ramp, from the level C, and the command to switch from CC state 0 to state 1 at the start of the current ramp, from the level A, is virtually zero, combined with a time t3 at the end of the current ramp-up rising to the level B that is relatively short, whereas the time t2 at the end of pressure rise of the controlled regulator 8 with a view to raising the cutting gas flow rate to the level D is relatively long, the cutting current ramp-up R_{A}^{B} and the cutting gas flow rate ramp-up R_{C}^{D} are not in synchronism. The gas flow rate levels required for correct operation do not correspond to the various current levels between the initial level A and the final level B since, during the current rise, there is undersupply of cutting gas.

This undersupply of cutting gas during the current rise generally causes “double” arcs between the nozzle and the workpiece to be cut, causing rapid damage or even destruction of the nozzle, making it unsuitable for the cutting operation that has to follow.

The problem to be solved is therefore to have a plasma cutting process and a plasma cutting unit which do not have the drawbacks and malfunctions of the prior art, and which therefore avoid the deleterious consequences on the execution of the cutting operation and on the longevity of the active components of the torch, in particular minimizing the rate of wear of the electrode.

The solution of the invention consists in slaving all or part of the cutting current ramp-up to the cutting gas pressure or flow rate ramp-up. This solution may advantageously be applied at the end of cutting, that is to say that it is possible to slave all or part of the current ramp-down to the pressure or flow rate ramp-down.

The solution of the invention is therefore a plasma cutting process for cutting a metal workpiece using a plasma cutting torch supplied with electrical current and with at least one plasma gas, characterized in that at least one portion of the current ramp-up used at the start of cutting and/or of the current ramp-down used at the end of cutting, respectively, is slaved to the ramp-up in pressure and/or in flow rate of the gas used, at least at the start of cutting, and/or the ramp-down in pressure and/or in flow rate of the gas used, at least at the end of cutting.

Depending on the case, the process of the invention may include one or more of the following technical features:
the current has an intensity of between 0 and 2000 A, preferably between 0 and 900 A;
the flow rate of the gas is between 0 and 500 l/min, preferably between 0 and 150 l/min;
the pressure of the gas is between 0 and 20 bar, preferably between 0 and 10 bar;
the slaving is obtained using at least one information item or signal delivered by a pressure or flow rate sensor that measures the pressure or the flow rate of the cutting gas;
when the pressure or flow rate sensor measures or detects a pressure or flow rate of the cutting gas during a step in which the pressure or flow rate rises or falls, respectively, from a first level (C) to a second level (D) according to a ramp (RC) of predetermined duration (t2), the said sensor delivers at least one information item or signal in such a way as to control the electrical current source that delivers the current in order to jointly start a current ramp (R_{A}^{B}) for increasing or decreasing, respectively, the value of the said current from a first level (A) to a second level (B);
the start of the current ramp (R_{A}^{B}) is initiated only when the pressure or the flow rate of cutting gas has reached a predetermined level (Q1) during a step in which the pressure or flow rate rises from a first level (C) to a second level (D) according to the ramp (R_{C}^{D}) of predetermined duration (t2) where the said predetermined level (Q1) lies between the first level (C) and the second level (D);
during all or part of the duration of the ramp (R_{C}^{D}) taking the pressure or the flow rate of cutting gas from a first level (C) to a second level (D), the current is periodically slaved with a frequency (fe) to the said gas ramp in such a way as to take the said current from a first level (A) to a second level (B) in a progression of successive stages, preferably with an amplitude governed by a law of proportionality that takes account of the pressure or flow rate and nature of the gas, with a total duration substantially equal to that of the gas ramp (RC);
the pressure or flow rate is measured on a gas line conveying the cutting gas to the cutting torch, at a point on the gas line located between an isolating valve placed on the said gas line and the said torch, preferably in the immediate vicinity of the torch, that is to say as close as possible to the torch, thereby making it possible to obtain a more reliable measurement;
the sensor delivers an information item or analogue signal of the voltage type or current type to the electrical current source.

The invention also relates to a plasma cutting unit comprising at least:
a plasma cutting torch with an electrode (non-consumable);
an electrical current source connected via one of its poles to the electrode of the torch;
a source of pilot (or ignition) gas supplying the torch via at least one pilot gas feed line in which a first pressure-regulating means, for regulating the pilot gas pressure, and a first isolating valve, for opening or closing the pilot gas line supplying the torch with pilot gas, are placed;
a source of cutting gas supplying the torch via at least one cutting gas feed line in which a second pressure-regulating means, for regulating the cutting gas pressure, and a second isolating valve, for opening or closing the cutting gas line supplying the torch with cutting gas, are placed; and
a control device for controlling the operating sequences of the plasma cutting unit by opening/closing the isolating valves and increasing/decreasing the current delivered by the electrical source for the ignition phases and for the cutting phases;
   characterized in that it furthermore includes a pressure or flow rate sensor placed in the cutting gas feed line between the cutting gas isolating valve and the torch.

Depending on the case, the unit of the invention may include one or more of the following technical features:
the sensor is placed near the torch, preferably as close as possible to the torch, in the cutting gas feed line;
it includes an electrical line that electrically connects the sensor to the current source or to the device for controlling the current delivered by the source;
the pressure or flow rate sensor delivers a signal substantially proportional to the pressure or the flow rate of cutting gas that it detects in the cutting gas feed line; and
the pressure or flow rate sensor delivers a 0 to 10 V or 0 to 20 mA analogue signal.

The invention will be described below in greater detail with reference to the illustrative FIGS. 5 to 8 appended hereto.

FIG. 5 shows diagrammatically a device for implementing the invention.

Added to the plasma cutting unit of FIG. 1, which by way of example serves as a basis for creating a device according to the invention, is a pressure or flow rate sensor 12 between the cutting gas isolating valve 9 and the torch 2. Preferably, the sensor 12 is placed as close as possible to the torch 2.

An electrical line 12′ connects the sensor 12 to the device for controlling the current delivered by the source 1.

The pressure or flow rate sensor 12 delivers, for example, a 0 to 10 V or 0 to 20 mA analogue signal substantially proportional to the pressure or to the flow rate of cutting gas that it detects.

Given that the problems associated with controlling the cutting gas and cutting current ramps in the phase prior to the start of cutting and in the phase at the end of cutting are similar, as previously only the phase prior to the start of cutting will be described below with reference to FIGS. 5 to 8.

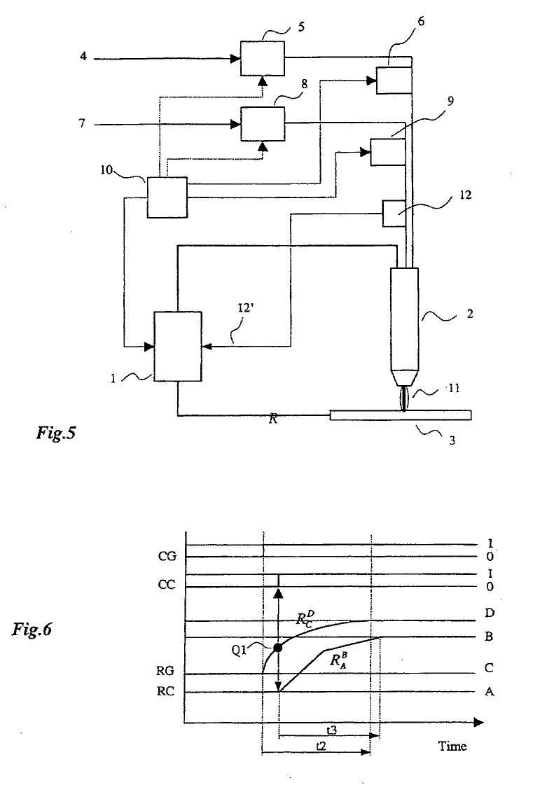

FIG. 6 shows, in the form of a graph, a first example of slaving according to the invention.

The synchronism between the command to switch from CG state 0 to state 1, governing the cutting gas RG, and the command to switch from CC state 0 to state 1, governing the current RC, is no longer determined by a time delay but by information delivered by the sensor 12 of FIG. 5.

When the sensor detects a pressure or a flow rate of predetermined level Q1, during the rise in pressure or flow rate from level C to level D according to the ramp R_{C}^{D} of predetermined duration t2, the device for controlling the current from the electrical source 1 then receives a current control command CC that determines the start of the current ramp R_{A}^{B} of predetermined duration t3 during which the current is raised from an initial level A to a final level B.

Since the information delivered by the sensor 12 is analogue information, of the voltage type (e.g. 0 to 10 V) or of the current type (e.g. 0 to 20 mA), the pressure of flow rate level Q1, given for example as a threshold below which a current rise cannot take place without damaging the active components of the torch, corresponds to a particular voltage or current level delivered by the sensor 12, which is detected and interpreted by an appropriate device as a current control command CC that almost instantaneously triggers the current rise according to the ramp R_{A}^{B} of pre-determined duration t3.

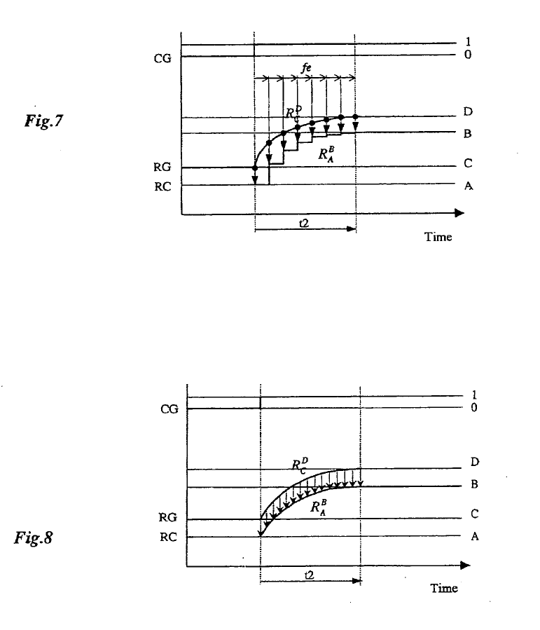

FIG. 7 shows a graph of a second example of slaving according to the invention.

The pressure or flow rate sensor 12 permanently delivers its voltage (0 to 10 V) or current (0 to 20 mA) information substantially proportional to the pressure or to the flow rate of cutting gas that it detects during the ramp-up R_{C}^{D} in which the cutting gas pressure or flow rate RG rises from an initial level C to a final level D.

After the command to switch from the 0 state to the 1 state of the cutting gas CG and during the ramp-up R_{C}^{D} in which the cutting gas pressure or flow rate RG rises over a predetermined time t2, the device for controlling the current of the source 1 permanently receives, via the electrical line 12′, the voltage or current information coming from the sensor 12.

The device for controlling the current from the source 1, by sampling at a frequency fe, converts the voltage or current information coming from the sensor 12 into a cutting current command delivered to the torch 2 that is substantially proportional to the voltage or to the current delivered by the sensor 12 and according to a pre-established law of synergy taking into account, for example, the nature of the gas flowing.

During the ramp-up R_{C}^{D}, of pre-established duration t2, in which the cutting gas pressure or flow rate RG rises, the pressure or flow rate of cutting gas is raised from the initial level C to the level D, and at the same time the cutting current RC is raised from the initial level A to the level B in a staircase-shaped current ramp-up R_{A}^{B}, the step height of which, in other words the same cutting current level, is determined by the pre-established law of synergy and the step length of which, in other words the duration over which the said cutting current level is maintained, is determined by the sampling frequency fe.

FIG. 8 shows a graph of a third example of slaving according to another aspect of the invention.

The pressure or flow rate sensor 12 permanently delivers its voltage (0 to 10 V) or current (0 to 10 mA) information substantially proportional to the pressure or to the flow rate of cutting gas that it detects during the ramp-up R_{C}^{D} in which the cutting gas pressure or flow rate RG rises from an initial level C to a final level D.

After the command to switch from the 0 state to the 1 state of the cutting gas CG and during the ramp-up R_{C}^{D} in which the cutting gas pressure or flow rate RG rises for a pre-established duration t2, the device for controlling the current from the source 1 permanently receives, via the electrical line 12′, the voltage or current information coming from the sensor 12.

The device for controlling the current from the source 1 converts, in real time and permanently, the voltage or current information coming from the sensor 12 into a work current command delivered to the torch 2 that is substantially proportional to the voltage or to the current delivered by the sensor 12 and according to a pre-established law of synergy taking into account, for example, the nature of the cutting gas flowing.

During the ramp-up R_{C}^{D}, of pre-established duration t2, in which the cutting gas pressure or flow rate RG rises, the pressure or the flow rate of the cutting gas is raised from the initial level C to the level D, and at the same time the cutting current RC is raised from the initial level A to the level B in a current ramp-up R_{A}^{B} continuously and closely associated with the ramp-up R_{C}^{D}, in which the cutting gas pressure or flow rate RG rises.

Compared with the processes and devices of the prior art, the invention has many advantages, namely:
the cutting current rise takes place only when the cutting gas pressure or flow rate conditions required are actually satisfied at the torch, this being so irrespective of any modifications made to the adjustment or to the programming of duration t2 of the cutting gas ramp-up R_{C}^{D};
this system guarantees very good matching between the cutting current rise and the cutting gas pressure or flow rate rise, eliminating any risk of an incorrect choice of the relative values of the times t1, t2 and t3 mentioned in particular with regard to FIGS. 2 to 4 and, by the same token, prevents premature wear of the electrodes and of the nozzles, prevents the plasma arc from being blown out and avoids any degradation in cutting quality;
this system may be advantageously used for negotiating the end-of-cutting phase by controlling, in an analogous manner but in the opposite way to the current rise phase, in preperation for the cutting operation proper, the cutting current from the level B down to a zero current level by slaving the said cutting current to the cutting gas ramp-down. In the same way as previously, the lifetime of the active components is thereby greatly increased and the overall cutting result greatly improved;
the system may also be used to monitor the pressure or flow rate variations during the actual cutting operation. In other words, the slaving of the cutting current to the cutting gas pressure or flow rate may be maintained during the actual cutting operation, while the cutting pressure or flow rate is supposed to remain at a fixed and stable level D, so as to detect any unintentional reductions in pressure or flow rate that are due, for example, to an inadvertent leak, rupture of a pipe or draining of the cutting gas storage tank, and to adjust the cutting current level according to a predetermined law of synergy, which is the same as or different from those used for the start-of-cutting and/or end-of-cutting phase, depending on the variation detected by the sensor 12, or else to cut off the cutting current below a predetermined threshold; and
the slaving of the cutting current to the cutting gas pressure or flow rate may be used during the actual cutting operation in order to remain closely synchronized irrespective of the intentional programme-controlled pressure or flow rate variations or those resulting from slaving the said pressure or the said flow rate to the variations in cutting speed that are programme-controlled or generated by a computer of the CNC (Computer Numerical Control) type as the paths involved in cutting shapes are being executed.

### EXAMPLE

By way of non-limiting example of the practical application of the invention, a table is given below showing the relationships used for slaving the current rises, up to 120 A, or the current drops, to the variations in the cutting gas flow rate when a torch of OCP 150 type combined with a unit of NERTAJET HP 125 type, both these being sold by Air Liquide Welding, are used for three different cutting gases given in the table below.

The flow rate sensor used was of the 0-10 V linear response type able to measure a flow rate ranging up to a full-scale (10 V) value of 50 l/min with a conversion coefficient given by voltage U₍ᵥₒₗₜₛ₎=0.2×flow rate Q_{(l/min)}.

The current setpoint imposed by the slaving to the device for controlling the current from the electrical source was: I₍ₐₘₚₛ₎=k U₍ᵥₒₗₜₛ₎, where:
U₍ᵥₒₗₜₛ₎ is the voltage delivered by the flow rate sensor; and
k is the conversion coefficient for the voltage U₍ᵥₒₗₜₛ₎, delivered by the flow rate sensor with the current setpoint I₍ₐₘₚₛ₎ according to the cutting gas used.

The values of the coefficient k are given in the table below according to the nature of the cutting gas.

TABLE

| Nature of the cutting gas | Value of k |
|---|---|
| Oxygen | 50.8475 |
| Nitrogen | 28.5715 |
| Mixture (argon/20 vol % | 12.766 |
| hydrogen) | |

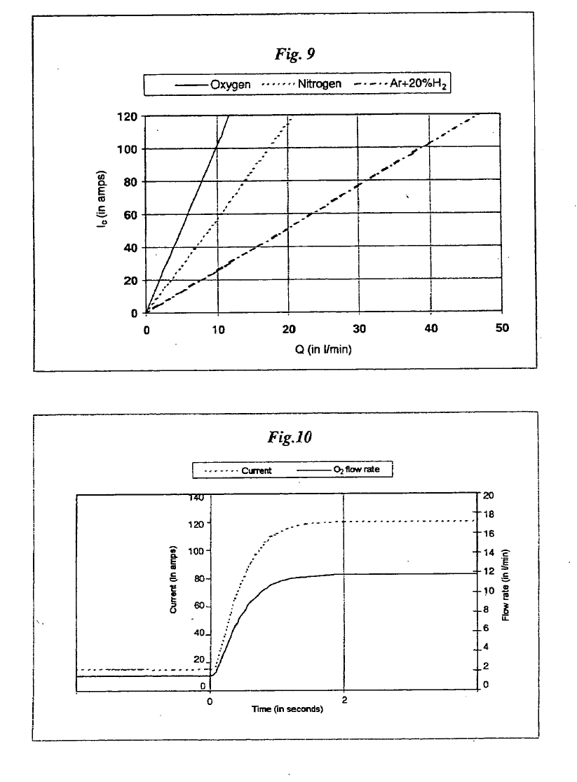

FIG. 9 gives the resulting curves (I_{c}=f(Q)) for which the cutting current is slaved to the cutting gas flow rate according to the nature of the cutting gas.

Furthermore, FIG. 10 shows, in the form of a graph, a practical application of slaving the cutting current to a plasma gas flow rate ramp-up.

In this case, the cutting gas was oxygen, the initial gas flow rate was 1.5 l/min and the final gas flow rate was 11.8 l/min.

The duration of the gas ramp (t2) was 2 seconds.

The initial cutting current was 15 A, while the final cutting current was 120 A.

The graph shows that, over the time interval between 0 and 2 seconds, there is perfect synchronism between the gas ramp-up and the current ramp-up.

The process of the invention, applied in particular to the series of plasma arc power increases and to the series of arc power reductions until the arc is finally extinguished, makes it possible to preserve the electrodes and the nozzles from premature wear due to an undersupply of plasma gas during the current rise, to avoid inadvertently blowing out the arc during the rise in gas flow rate, and in general to guard against any accidental deterioration in the cutting quality.

1-13. (canceled)

14-26. (canceled)

27. A method which may be used for cutting a metal workpiece, said method comprising cutting a metal workpiece with a plasma cutting torch, wherein:
a) said torch is supplied with an electrical current and with at least one plasma gas; and
b) at least one characteristic of said current depends upon at least one characteristic of said gas, wherein:
1) said characteristic of said current comprises at least one member selected from the group consisting of:
i) an increase in said current at the start of said cutting; and
ii) a decrease in said current at the end of said cutting;
2) said characteristic of said gas comprises at least one member selected from the group consisting of:
i) an increase in the pressure of said gas;
ii) an increase in the flow rate of said gas;
iii) a decrease in said pressure of said gas; and
iv) a decrease in said flow rate of said gas.

28. The method of claim 27, further comprising obtaining at least one item of information with a sensor, wherein:
a) said item is used to control the dependency of said characteristic of said current to said characteristic of said gas;
b) said sensor comprises at least one member selected from the group consisting of:
1) a flow rate sensor for measuring the flow rate of said gas; and
2) a pressure sensor for measuring the pressure of said gas.

29. The method of claim 28, further comprising sending at least one signal from said sensor to the electrical current supply source, wherein:
a) said signal is sent when said sensor detects a change, from a first gas level to a second gas level, in said characteristic of said gas according to a gas ramp of a first predetermined duration; and
b) said signal causes said current to change, from a first current level to a second current level, according to a current ramp.

30. The method of claim 29, wherein
a) said current ramp begins when during said gas ramp, said characteristic of said gas reaches a third gas level; and
b) said third gas level lies between said first gas level and said second gas level.

31. The method of claim 29, wherein:
a) during said gas ramp, said current ramp corresponds to said gas ramp with a first frequency such that said current changes from said first current level to said second current level in a series of successive stages; and
b) said current ramp has a duration substantially equal to that of said gas ramp.

32. The method of claim 31, wherein said successive stages have an amplitude governed by a law of proportionality that takes into account said characteristic of said gas.

33. The method of claim 29, wherein:
a) during said gas ramp, said current ramp corresponds to said gas ramp such that said current changes from said first current level to said second current level in a substantially continuous progression; and
b) said current ramp has a duration substantially equal to that of said gas ramp.

34. The method of claim 33, wherein said continuous progression is governed by a law of proportionality that takes into account said characteristic of said gas.

35. The method of claim 29, wherein said signal comprises at least one member selected from the group consisting of:
a) an analog signal of the voltage type; and
b) an analog signal of the current type.

36. The method of claim 28, wherein said characteristic of said gas is measured at a location between an isolating valve on the gas line to said torch and said torch.

37. The method of claim 36, wherein said measurement is performed in the immediate vicinity of said torch.

38. An apparatus which may be used as a plasma cutting unit, said apparatus comprising:
a) a plasma cutting torch, wherein said torch comprises an electrode;
b) an electrical current source connected at one of its poles to said electrode;
c) a pilot gas supply source for supplying said torch with pilot gas, said pilot gas supply source comprising at least one pilot gas supply feed line, wherein said pilot gas feed line comprises;
1) a first pressure regulating means for regulating the pressure of said pilot gas; and
2) a first isolating valve located on said pilot gas feed line;
d) a cutting gas supply source for supplying said torch with cutting gas, said cutting gas supply source comprising at least one cutting gas feed line, wherein said cutting gas feed line comprises:
1) a second pressure regulating means for regulating the pressure of said cutting gas;
2) a second isolating valve located on said cutting gas feed line; and
3) a sensor located between said second isolating valve and said torch, wherein said sensor comprises at least one member selected from the group consisting of:
i) a pressure sensor; and
ii) a flow rate sensor; and
e) a control means for controlling the operating sequences of said apparatus by:
1) opening and closing said first and said second isolation valves; and
2) changing the current delivered by said electrical current source during the ignition and the cutting phases.

39. The apparatus of claim 38, wherein said sensor is located on said cutting gas line near said torch.

40. The apparatus of claim 39, wherein said senor is located as close as possible to said torch.

41. The apparatus of claim 38, further comprising an electrical line which connects said sensor to a component, wherein said component comprises at least one member selected from the group consisting of:
a) said electrical current source; and
b) said control means.

42. The apparatus of claim 38, wherein said sensor delivers a signal substantially proportional to a characteristic of said cutting gas, wherein said characteristic of said cutting gas comprises at least one member selected from the group consisting of:
a) the pressure of said cutting gas; and
b) the flow rate of said cutting gas.

43. The apparatus of claim 38, wherein said sensor delivers a signal, wherein said signal comprises at least one member selected from the group consisting of:
a) a signal between about 0 V to about 10 V; and
b) a signal between about 0 mA to about 20 mA.
